(19) United States
(12) Patent Application Publication
(10) Pub. No.: US 2018/0312448 A1
(43) Pub. Date: Nov. 1, 2018

(54) AUTOMATIC DISPENSING OF MICROBIAL SOIL ENHANCEMENT

(71) Applicant: Khanh Le, San Jose, CA (US)

(72) Inventor: Khanh Le, San Jose, CA (US)

(21) Appl. No.: 15/499,159

(22) Filed: Apr. 27, 2017

(51) Int. Cl. C05F 3/00; A23K 10/18; A23K 10/37; A23K 50/75; A23K 50/80; A23K 50/30; A23K 20/24; A23K 50/10; C05G 3/00

(52) U.S. Cl. CPC C05F 3/00; A23K 10/18; A23K 10/37; A23K 50/75; C05G 3/0064; A23K 50/30; A23K 20/24; A23K 50/10; C05G 3/0052; A23K 50/80

(57) ABSTRACT

A method for enhancing soil in a predetermined farming area includes selecting a plurality of strains of sporulated living microbes and form a microbial solution; infusing the microbes with a carrier for a predetermined animal; feeding the animal with the microbes infused carrier; excrementing the microbes infused carrier as the animal moves around the area to receive the soil enhancement; and upon receipt of liquid, activating the microbes to perform soil enhancement.

### BACKGROUND

The present invention relates to automatic dispensing of soil enhancements.

Fertilizer application equipment can apply chemicals in dry or liquid form. The appropriate equipment places the material at the desired rate in the desired location. In bareroot nurseries, fertilizer is usually applied dry in granulated pellets or coated form. In container production, nutrients may be applied in granular slow-release form or, more commonly, injected directly into the irrigation water supply, otherwise known as fertigation.

The application equipment selected will depend, of course, on the farm's specific needs—and those of the plants grown. And unless the farm grows only one species, a variety of reliable machines are needed. Drop-type fertilizer distributor can be used—tractor-mounted and trailer machines are available; hand-pushed distributors generally are used for small beds. Dry fertilizer is loaded into a hopper, which has a V-bottom with agitator and adjustable gates that control the rate of flow through the holes. Hopper widths are available from 2 to 12 feet and spread the fertilizer over the bed. For batch mixing, granular fertilizer can be dumped into the mixer along with other components before the medium is blended. For continuous mixing, a fertilizer dispenser meters the chemical onto the conveyor belt before components reach the mixing unit. Broadcast spreader (a spin or cyclone spreader) can be used where one or two spinning disks located below the hopper and powered by the tractor or a set of drive wheels distribute the fertilizer. Application rate is controlled by a slide gate. Ground coverage is greater than with the drop-type distributor, but uniformity is not as good. Seed drills can be fitted with fertilizer hoppers that apply chemicals at the same time seeding is done. Metering devices include the star wheel, feed roll, wire worm or auger. Drop tubes direct the fertilizer into the same furrow as the seed. Liquid fertilizer can also be injected into the soil. Individual pot applicators feed small quantities into individual containers. The hopper holds a quantity of fertilizer that can be conveniently carried. A measuring device meters the chemical and drops it into the pot, and several thousand pots can be fed per hour. The size of the nursery and the type of plant being grown influence applicator selection. Even if the farm production covers hundreds of acres, a large machine may be too expensive to own and difficult to maneuver in small areas. On the other hand, a small machine may require frequent stops for refilling. Complex decisions need to be made, for example:

Drop or broadcast spreaders take less power than drills. Stony soil is less of a problem.

Placement of the fertilizer can affect the growth of the crop. Fertilizer placed on top of the soil may take time before it reaches the root system.

Fertilizer applicators are heavy when full. Flotation tires may be a good investment, especially if the application is made when the soil is wet.

If a tractor is available, it needs to be sized to fit it. Some manufacturers list horsepower requirements for their machines.

Because fertilizers are corrosive, many modern applicators have stainless steel or plastic parts. Nevertheless, machines should be cleaned after each use.

Ease of calibration is important for accurate application, and especially to avoid the cost and possible adverse effects of overfertilization. It should be done with each change of fertilizer material. Follow the instruction manual to make the correct adjustments; rates of fertilization may differ from application to application, so be sure to consult the product's label each time.

Fertigation is the controlled feeding of nutrients to plants through the irrigation system. Application of fertilizer through the water system has several advantages:

Easy adjustment of nutrients, depending on crop needs.

Nutrients become available to the plants quicker.

More accurate placement of fertilizer.

Less fertilizer needed.

Reduced labor to apply fertilizer.

Irrigation can be done with many systems; four are described here.

Overhead

Lateral supply lines feed sprinklers that produce a circular pattern for outdoor plants in the nursery or for seedlings growing in a greenhouse. To be effective, a pattern of at least 60 percent overlap is needed to achieve uniform coverage.

Boom irrigator equipment provides water with a boom that travels over the growing area is available for both outdoor and greenhouse production. This system is the best method for watering plug and cell trays, as very uniform application can be made. Both hand-operated and motorized, computer-controlled booms are available. Drippers can be viable for beds and larger containers, which result in considerable savings in water and nutrients. Clean water is required. Pressure compensating drippers are required for sloping beds to receive uniform distribution. High-output drippers are now available; these help achieve quicker application of water with less clogging. Mats, trays, benches and flooded floors are systems where the nutrient solution is absorbed by the growing media from underneath the container. Used in the greenhouse or on limited outdoor production areas, these systems work best with small containers and plug trays.

The injector must be compatible with the water flow rate in gallons per minute. Most injectors have a range of flow over which they will operate. Select one that will allow for some expansion should a different irrigation system be installed, but don't oversize it, as larger injectors may not work when only one hose is turned on.

Except for the Venturi type, all injectors have variable dilution ratios. This is desirable, as available concentrations or the size of the mixing tank may require different ratios. Check on the ease of changing the ratio.

Injectors with an integral mixing tank are available in several sizes. A separate concentrate supply is needed for most injectors. A 5-gallon pail is adequate for one hoophouse. Larger plastic or concrete tanks can also be used. Select a tank large enough to feed a single greenhouse or several zones to reduce frequency of refilling. In larger ranges, nutrient concentrate may be distributed from a central tank throughout the range in PVC pipe. Agitation within the tank is important to maintain a uniform solution.

Fixed units are used in small operations or where all irrigation water is piped to the greenhouses. Portable units can be moved from one area to another.

Multiple injector units are required where more than one chemical is applied at the same time. They are also used where individual nutrient levels are monitored by a computer.

Check the specifications for the amount of pressure loss caused by the injector. Some units lose as much as 15 psi. For some water systems, this may limit the amount of hoses or number of zones that can be operated at one time. Also, be sure that piping is large enough to keep pressure loss to a minimum.

For large operations, an injector that can be integrated into the computer system is desirable. Sensors, pumps and water meter should be compatible with the software.

Check to see if the injector is compatible with the chemicals that you will be applying. Water should also be clean to avoid wear. Most manufacturers recommend that a 200-mesh filter be inserted before the injector.

Safety devices should be installed in the system to prevent backflow into the water source. A backflow preventer is required on all systems connected to potable water. A check valve should be installed in the chemical injection supply line. An interlock should be installed to prevent an electrical injector pump from operating if the water flow stops. Repair parts and dependable service should be available locally.

Injector operation must be checked frequently and calibrated to ensure proper operation and application rate. Follow the manufacturer's recommendations for calibration.

The above methods are complex to use and require equipment and are environmentally unsustainable.

### SUMMARY OF THE INVENTION

In one aspect, a method for enhancing soil in a predetermined farming area includes selecting a plurality of strains of sporulated living microbes and form a microbial solution; infusing the microbes with a carrier for a predetermined animal; feeding the animal with the microbes infused carrier; excrementing the microbes infused carrier as the animal moves around the area to receive the soil enhancement; and upon receipt of liquid, activating the microbes to perform soil enhancement.

In another aspect, an apparatus includes a container for a carrier selected based on a predetermined animal:

for grazing animal, one of hull, wheat, and dendritic salt,

for poultry, dendritic salt or calcium carbonate,

for aquatic animal, dendritic salt;

for swine, dendritic salt or calcium carbonate; and

a microbial container housing a microbial solution with a plurality of strains of sporulated living microbes, wherein the microbial solution is applied to the carrier to form animal food; and a source of liquid to activate the microbes after excretion.

In a further aspect, a method for feeding animals includes selecting a plurality of strains of sporulated living microbes and form a microbial solution; infusing a carrier such as hulls or shells with the microbial solution; feeding animals with the microbial infused carrier and delivering microbes to a gastrointestinal tract alive; and germinating the microbes in the digestive tract and stimulating local intestinal immunity with the microbes.

In yet another aspect, a method for feeding animals includes selecting a plurality of strains of sporulated living microbes and form a microbial solution; selecting as a carrier for a predetermined animal:
for grazing animal, one of hull, wheat, and dendritic salt,
for poultry, dendritic salt or calcium carbonate,
for aquatic animal, dendritic salt;
for swine, dendritic salt or calcium carbonate.
   The microbial solution is then applied to the carrier.

Implementations of the above aspects may include one or more of the following. The microbes can be selected from Bacillus (B.) acidiceler, B. acidicola, B. acidiproducens, B. acidocaldarius, B. acidoterrestrisr, B. aeolius, B. aerius, B. aerophilus, B. agaradhaerens, B. agri, B. aidingensis, B. akibai, B. alcalophilus, B. algicola, B. alginolyticus, B. alkalidiazotrophicus, B. alkalinitrilicus, B. alkalisediminis, B. alkalitelluris, B. altitudinis, B. alveayuensis, B. alvei, B. amyloliquefaciens, B. a. subsp. amyloliquefaciens, B. a. subsp. plantarum, B. amylolyticus, B. andreesenii, B. aneurinilyticus, B. anthracia, B. aquimaris, B. arenosi, B. arseniciselenatis, B. arsenicus, B. aurantiacus, B. arvi, B. aryabhattai, B. asahii, B. atrophaeus, B. axarquiensis, B. azotofixans, B. azotoformans, B. badius, B. barbaricus, B. bataviensis, B. beijingensis, B. benzoevorans, B. beringensis, B. berkeleyi, B. beveridgei, B. bogoriensis, B. boroniphilus, B. borstelensis, B. brevis Migula, B. butanolivorans, B. canaveralius, B. carboniphilus, B. cecembensis, B. cellulosilyticus, B. centrosporus, B. cereus, B. chagannorensis, B. chitinolyticus, B. chondroitinus, B. choshinensis, B. chungangensis, B. cibi, B. circulans, B. clarkii, B. clausii, B. coagulans, B. coahuilensis, B. cohnii, B. composti, B. curdlanolyticus, B. cycloheptanicus, B. cytotoxicus, B. daliensis, B. decisifrondis, B. decolorationis, B. deserti, B. dipsosauri, B. drentensis, B. edaphicus, B. ehimensis, B. eiseniae, B. enclensis, B. endophyticus, B. endoradicis, B. farraginis, B. fastidiosus, B. fengqiuensis, B. firmus, B. flexus, B. foraminis, B. fordii, B. formosus, B. fortis, B. fumarioli, B. funiculus, B. fusiformis, B. galactophilus, B. galactosidilyticus, B. galliciensis, B. gelatini, B. gibsonii, B. ginsengi, B. ginsengihumi, B. ginsengisoli, B. globisporus, B. g. subsp. globisporus, B. g. subsp. marinus, B. glucanolyticus, B. gordonae, B. gottheilii, B. graminis, B. halmapalus, B. haloalkaliphilus, B. halochares, B. halodenitrificans, B. halodurans, B. halophilus, B. halosaccharovorans, B. hemicellulosilyticus, B. hemicentroti, B. herbersteinensis, B. horikoshii, B. horneckiae, B. horti, B. huizhouensis, B. humi, B. hwajinpoensis, B. idriensis, B. indicus, B. infantis, B. infernus, B. insolitus, B. invictae, B. iranensis, B. isabeliae, B. isronensis, B. jeotgali, B. kaustophilus, B. kobensis, B. kochii, B. kokeshiiformis, B. koreensis, B. korlensis, B. kribbensis, B. krulwichiae, B. laevolacticus, B. larvae, B. laterosporus, B. lautus, B. lehensis, B. lentimorbus, B. lentus, B. licheniformis, B. ligniniphilus, B. litoralis, B. locisalis, B. luciferensis, B. luteolus, B. luteus, B. macauensis, B. macerans, B. macquariensis, B. macyae, B. malacitensis, B. mannanilyticus, B. marisflavi, B. marismortui, B. marmarensis, B. massiliensis, B. megaterium, B. mesonae, B. methanolicus, B. methylotrophicus, B. migulanus, B. mojavensis, B. mucilaginosus, B. muralis, B. murimartini, B. mycoides, B. naganoensis, B. nanhaiensis, B. nanhaiisediminis, B. nealsonii, B. neidei, B. neizhouensis, B. niabensis, B. niacini, B. novalis, B. oceanisediminis, B. odysseyi, B. okhensis, B. okuhidensis, B. oleronius, B. oryzaecorticis, B. oshimensis, B. pabuli, B. pakistanensis, B. pallidus, B. pallidus, B. panacisoli, B. panaciterrae, B. pantothenticus, B. parabrevis, B. paraflexus, B. pasteurii, B. patagoniensis, B. peoriae, B. persepolensis, B. persicus, B. pervagus, B. plakortidis, B. pocheonensis, B. polygoni, B. polymyxa, B. popilliae, B. pseudalcalophilus, B. pseudofirmus, B. pseudomycoides, B. psychrodurans, B. psychrophilus, B. psychrosaccharolyticus, B. psychrotolerans, B. pulvifaciens, B. pumilus, B. purgationiresistens, B. pycnus, B. qingdaonensis, B. qingshengii, B. reuszeri, B. rhizosphaerae, B. rigui, B. ruris, B. safensis, B. salarius, B. salexigens, B. saliphilus, B. schlegelii, B. sediminis, B. selenatarsenatis, B. selenitireducens, B. seohaeanensis, B. shacheensis, B. shackletonii, B. siamensis, B. silvestris, B. simplex, B. siralis, B. smithii, B. soli, B. solimangrovi, B. solisalsi, B. songklensis, B. sonorensis, B. sphaericus, B. sporothermodurans, B. stearothermophilus, B. stratosphericus, B. subterraneus, B. subtilis, B. s. subsp. inaquosorum, B. s. subsp. spizizenii, B. s. subsp. subtilis, B. taeanensis, B. tequilensis, B. thermantarcticus, B. thermoaerophilus, B. thermoamylovorans, B. thermocatenulatus, B. thermocloacae, B. thermocopriae, B. thermodenitrificans, B. thermoglucosidasius, B. thermolactis, B. thermoleovorans, B. thermophilus, B. thermoruber, B. thermosphaericus, B. thiaminolyticus, B. thioparans, B. thuringiensis, B. tianshenii, B. trypoxylicola, B. tusciae, B. validus, B. vallismortis, B. vedderi, B. velezensis, B. vietnamensis, B. vireti, B. vulcani, B. wakoensis, B. weihenstephanensis, B. xiamenensis, B. xiaoxiensis, and B. zhanjiangensis.

Advantages of the solutions may include one or more of the following. The technique simulataneously feeds animals AND fertilizes the land. This is done without any complicated equipment selection done by the prior art. Cost is low, and the result is environmentally sustainable. One embodiment called PROBIOFEED provides a natural and unique blend of specifically selected beneficial bacteria & probiotic additives to promote wellbeing of animals by preventing bacteria and parasitic contamination. Beneficial bacteria are essential to all life, PROBIOFEED will enhance the animals immunity, improving digestibility, improve intestinal health, increase animal survival rate and resistance to bad pathogen and diseases. More importantly, PROBIOFEED promotes animal growth and feed efficiency, which will add to a farmer's bottom line.

These and other advantages are achieved by the present invention, which provides a method of preserving and solutions containing microbial spores and/or colonies.

### BRIEF DESCRIPTION OF THE FIGURES

FIG. 1 shows an exemplary process to infuse hulls or shells with microbials for feeding animals.

FIG. 2A shows an exemplary digestive tract with nutrients, non-beneficial bacteria, lactobacilli and probiotics.

FIG. 2B shows exemplary probiotics actions.

FIG. 3 shows an exemplary process to form PROBIOFEED.

### DETAILED DESCRIPTION OF THE INVENTION

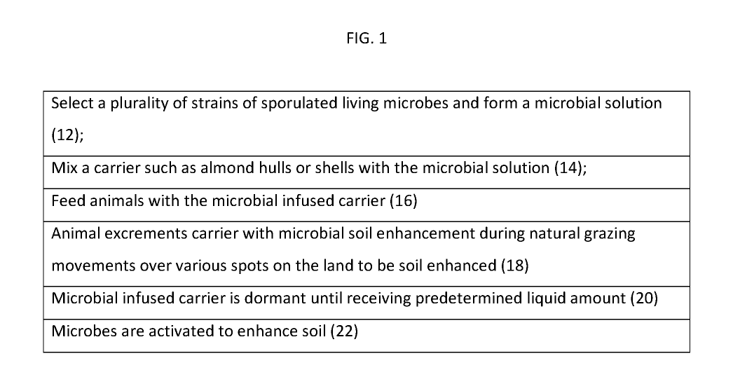

FIG. 1 shows an exemplary process to naturally enhance soils without machinery. This is done by providing microbes as part of the feed and as the animal such as cow moves around the planting area, the animal excrete the microbes into the soil which is subsequently activated with a liquid such as water. The process includes:

Select a plurality of strains of sporulated living microbes and form a microbial solution (12);

Mix a carrier such as almond hulls or shells with the microbial solution (14);

Feed animals with the microbial infused carrier (16)

Animal excrements carrier with microbial soil enhancement during natural grazing movements over various spots on the land to be soil enhanced (18)

Microbial infused carrier is dormant until receiving predetermined liquid amount (20)

Microbes are activated to enhance soil (22)

Different carriers can be used. Beside hulls, the feed can use wheat or corn powder for carrier. Dendritic salt and grind up limestone or calcium carbonate can be used as well. The purpose of using salt as a carrier is to help the animal restore electrolytes in the body. This problem is often caused by extreme heat in the summer, mineral deficiency in winter and after severe diarrhea. The salt will not only help retain water, electrolytes in the body, but also increases appetite. Wheat, hull, corn carriers provide more nutrients in the diet but should be used when the animal is healthy during a normal growing cycle. For example, grazing animals, the feed includes hull, wheat, and dendritic salt for the carrier, depending on the season. For poultry, the feed includes dendritic salt or calcium carbonate. For aquatic fish and other creatures, dendritic salt is used. For swine, the feed can include dendritic salt or calcium carbonate.

In one embodiment called PROBIOFEED, the solution contains several strains of bacillus spp to ensure a broad spectrum product that can work in wide variety of environmental applications. The Bacillus spp germinates in upper digestive tract and display their activity in those sections of intestine which are relevant for nutrient absorption. Bacillus is selected as a sporulated living microorganism with the ability to form spores. They reach the gastrointestinal tract alive and stimulates local intestinal immunity.

Various cell walls that protect the nucleus from external stresses enable the Bacillus products to withstand massive stress during feed production and storage caused by 1) High temperature, 2) Pressure, 3) Shear forces, and 4) Oxidation impacts. In some embodiments, selected cell walls are used as a protective structure/mechanism for producing the Bacillus included products.

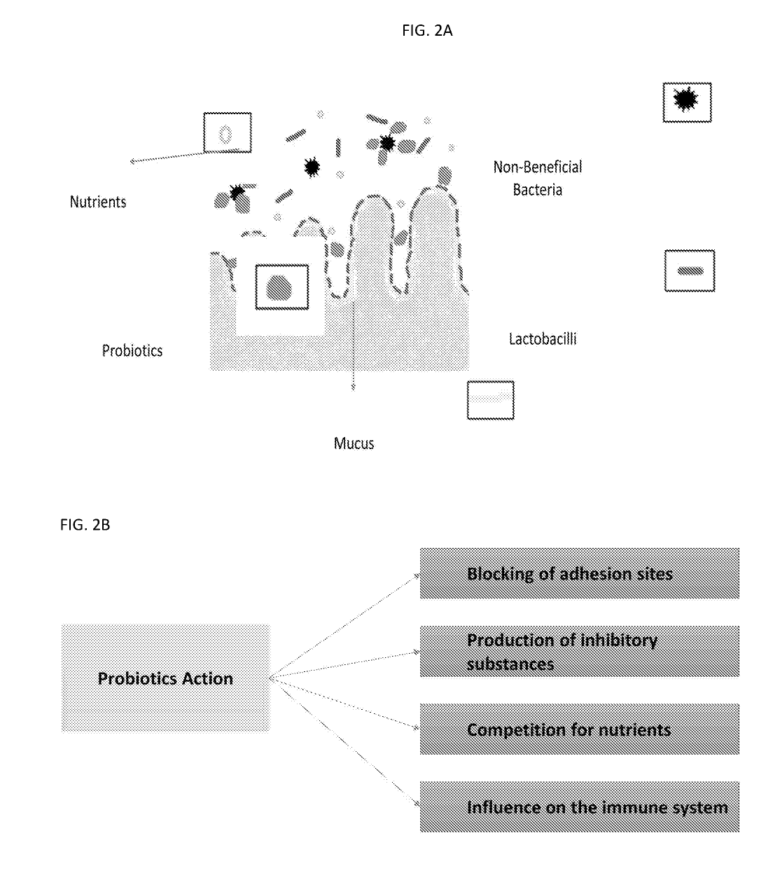

FIG. 2A shows an exemplary digestive tract with nutrients, non-beneficial bacteria, lactobacilli and probiotics. As detailed in FIG. 2B, probiotics actions include: blocking of adhesion sites, production of inhibitory substances, competition for nutrients, and influencing the immunity system. The benefits include improved digestibility of nutrients and detoxification of toxic molecules and improved vitamin synthesis (B and K). This provides an environmental friendly animal husbandry.

The probiotics provide antagonistic action against non-desirable microorganisms (barrier effect) and protects the intestinal mucous membrane against invading microorganisms. They contribute to maturation and stimulation of the host's immune system; improve growth and survivability of the animal; and reduce feed cost. The probiotics also improve feed conversion (FCR), decrease by 1%-5% and improves daily weight gain (DWG), increase by 3%-5%. Yet other benefits include one or more of the following:
Increased production and survivability
Reduced risk of digestive problems
Improved nutrients absorption
Uniform growth and better homogeneity of the groups
Reduced fattening period
Reduced feed expenditure
Reduced medication costs
Reduced slurry nutrient content (lower nitrogen excretion for example)

Next, exemplary results on probiotics on the performance of animals are shown as follows:

Influence of Various Probiotics on the Performance of Animals

| Production branch | DWG (% of control) | FCR (% of control) |
|---|---|---|
| Piglet production | +4.8 | −1.5 |
| | (−8.1 to +24.3) | (+3.1 to −9.3) |
| Calf production | +5.4 | −2.5 |
| | (−5.3 to +21.7) | (+3.6 to −7.9) |
| Growing/fattening pigs | +3.7 | −5.1 |
| | (−0.3 to+6.7) | (−1.4 to −7.1) |
| Growing/fattening cattle | +3.4 | −2.7 |
| | (−4.3 to+7.2) | (+7.6 to −4.7) |

Influence of Probiotics on Protein Digestibility and Crude Protein Deposition in Piglets

| Nitrogen | | Nitrogen deposition | | |
|---|---|---|---|---|
| digestibility (%) | | (g W^{-0.75} per day)¹ | | |
| Control | Probiotic** | Control | Probiotic** | Authors |
| 81.05^{a} | 82.86^{b} | 1.24^{a} | 1.34^{b} | S E Scheuemann, 1993 |
| 78.70^{c} | 83.20^{d} | 1.76 | 1.81 | Tossenberger et al., 1995 |

¹Relative to metabolic body weight
**dosage 1 × 10⁹ CFU per kg of piglet feed
^{a},^{b},^{c},^{d}significant differences

To feed the animals, in various embodiments:
For feed blending as a pre-mixed or coating: about 0.5 gram per kilogram of feed
For per feed mixing (can be mixed to one meal per day): about 2 grams per kilogram of feed
For drinking dosage: about 2 grams per liter of water.

The microbes used for animal nutrition have a very good safety record. Even in cases of overdoses of more than thousand times recommended levels in feed, there're no signs of dysbiosis in the gastrointestinal tract. Probiotics do not constitute any health hazard for animal. Since they are not transferred from intestine into the body of animal, probiotics do not affect any metabolic processes, nor do they have any negative impact on the animal.

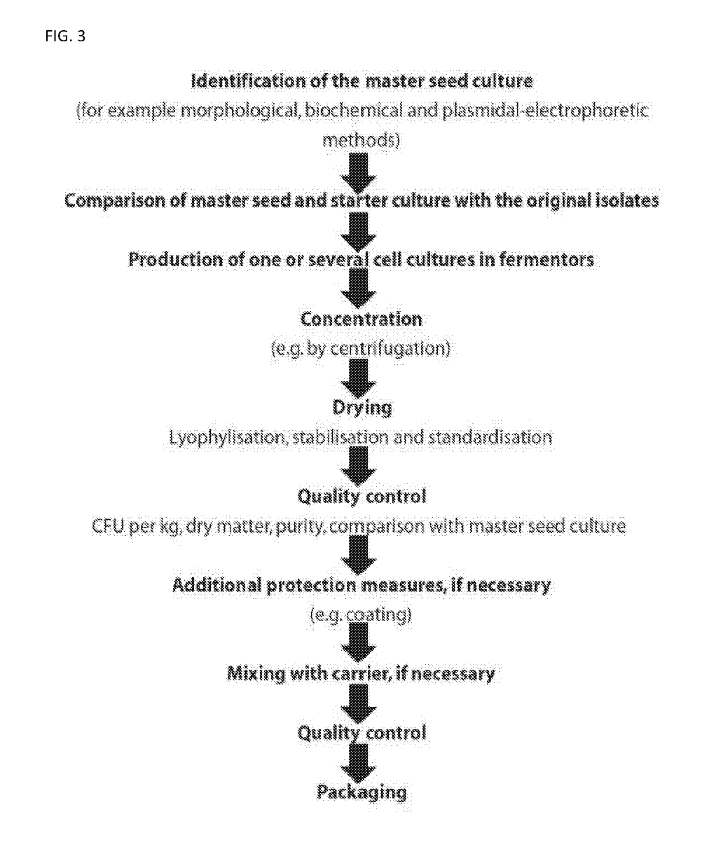

FIG. 3 shows an exemplary process to form PROBIOFEED. First, the master seed culture is identified. Next, the process compares the master seed and starter culture with the original isolates. One or more cell cultures are produced in fermenters, and the result can be concentrated by centrifugation, among others. The concentrated cell cultures can be dried using lyophilisation, stabilization, and standardization techniques. Quality control is then done and the result can be compared with the master seed culture. Additional protection measures can be applied, such as coating the dried cell cultures. The result can be mixed with a carrier if necessary, and then quality control can be done. The resulting PROBIOFEED composition can be packaged for shipping. PRO BIOFEED Final Packaging can include Bags/Buckets/Drums, among others.

Various exemplary microbial compositions are detailed next.

### Example 1

Microbes:
Bacillus pumilus 4.05×10̂8 CFU/g
Bacillus subtilis 6.30×10̂8 CFU/g
Bacillus amyloliquefaciens 5.85×10̂8 CFU/g
Bacillus lichniformis 1.80×10̂8 CFU/g

Amino Acids: Amino Acids

Dendritic Salt: Sodium Chloride

### Example 2

Microbes:
Bacillus licheniformis 2.28×10̂9 CFU/g
Bacillus subtilis 2.28×10̂9 CFU/g

Dendritic Salt: Sodium Chloride

### Example 3

Microbes:
Bacillus licheniformis 4.762×10̂9 CFU/g Amino Acids: Amino Acids Ground Lime Stone: Calcium Carbonate

### Example 4

Microbes:
Bacillus licheniformis 2.28×10̂9 CFU/g
Bacillus subtilis 2.28×10̂9 CFU/g

Almond Hull: Ground Almond Hull

### Example 5

Microbes:
Bacillus licheniformis 4.762×10̂9 CFU/g

Amino Acids: Amino Acids

Dendritic Salt: Sodium Chloride

### Example 6

Microbes:
Bacillus Subtilis 4.762×10̂9 CFU/g

Amino Acids: Amino Acids

Dendritic Salt: Sodium Chloride

The above description is for the purpose of illustrating and not limiting the present invention, and teaching the person of ordinary skill in the art how to practice the invention. It is not intended to detail all those obvious modifications and variations of it which will become apparent to the skilled worker upon reading the description. It is intended, however, that all such obvious modifications and variations be included within the scope of the present invention as defined in the appended claims. The claims are meant to cover the claimed components and steps in any sequence which is effective to meet the objectives there intended, unless the context specifically indicates the contrary.

The patents, papers, and book excerpts cited above are hereby incorporated herein by reference in their entireties.

What is claimed is:

1. A method for enhancing soil in a predetermined farming area, comprising:
selecting a plurality of strains of sporulated living microbes and form a microbial solution;
infusing the microbes with a carrier for a predetermined animal;
feeding the animal with the microbes infused carrier;
excrementing the microbes infused carrier as the animal moves around the area to receive the soil enhancement; and
upon receipt of liquid, activating the microbes to perform soil enhancement.

2. The method of claim 1, comprising selecting as a carrier for the predetermined animal:
for grazing animal, one of hull, wheat, and dendritic salt,
for poultry, dendritic salt or calcium carbonate,
for aquatic animal, dendritic salt;
for swine, dendritic salt or calcium carbonate; and
applying the microbial solution to the carrier.

3. The method of claim 1, comprising feeding animals with the microbial infused carrier to deliver microbes to a gastrointestinal tract alive.

4. The method of claim 3, comprising germinating the microbes in the digestive tract and stimulating local intestinal immunity with the microbes.

5. The method of claim 1, comprising selecting the microbe from Bacillus (B.) acidiceler, B. acidicola, B. acidiproducens, B. acidocaldarius, B. acidoterrestrisr, B. aeolius, B. aerius, B. aerophilus, B. agaradhaerens, B. agri, B. aidingensis, B. akibai, B. alcalophilus, B. algicola, B. alginolyticus, B. alkalidiazotrophicus, B. alkalinitrilicus, B. alkalisediminis, B. alkalitelluris, B. altitudinis, B. alveayuensis, B. alvei, B. amyloliquefaciens, B. a. subsp. amyloliquefaciens, B. a. subsp. plantarum, B. amylolyticus, B. andreesenii, B. aneurinilyticus, B. anthracia, B. aquimaris, B. arenosi, B. arseniciselenatis, B. arsenicus, B. aurantiacus, B. arvi, B. aryabhattai, B. asahii, B. atrophaeus, B. axarquiensis, B. azotofixans, B. azotoformans, B. badius, B. barbaricus, B. bataviensis, B. beijingensis, B. benzoevorans, B. beringensis, B. berkeleyi, B. beveridgei, B. bogoriensis, B. boroniphilus, B. borstelensis, B. brevis Migula, B. butanolivorans, B. canaveralius, B. carboniphilus, B. cecembensis, B. cellulosilyticus, B. centrosporus, B. cereus, B. chagannorensis, B. chitinolyticus, B. chondroitinus, B. choshinensis, B. chungangensis, B. cibi, B. circulans, B. clarkii, B. clausii, B. coagulans, B. coahuilensis, B. cohnii, B. composti, B. curdlanolyticus, B. cycloheptanicus, B. cytotoxicus, B. daliensis, B. decisifrondis, B. decolorationis, B. deserti, B. dipsosauri, B. drentensis, B. edaphicus, B. ehimensis, B. eiseniae, B. enclensis, B. endophyticus, B. endoradicis, B. farraginis, B. fastidiosus, B. fengqiuensis, B. firmus, B. flexus, B. foraminis, B. fordii, B. formosus, B. fortis, B. fumarioli, B. funiculus, B. fusiformis, B. galactophilus, B. galactosidilyticus, B. galliciensis, B. gelatini, B. gibsonii, B. ginsengi, B. ginsengihumi, B. ginsengisoli, B. globisporus, B. g. subsp. globisporus, B. g. subsp. marinus, B. glucanolyticus, B. gordonae, B. gottheilii, B. graminis, B. halmapalus, B. haloalkaliphilus, B. halochares, B. halodenitrificans, B. halodurans, B. halophilus, B. halosaccharovorans, B. hemicellulosilyticus, B. hemicentroti, B. herbersteinensis, B. horikoshii, B. horneckiae, B. horti, B. huizhouensis, B. humi, B. hwajinpoensis, B. idriensis, B. indicus, B. infantis, B. infernus, B. insolitus, B. invictae, B. iranensis, B. isabeliae, B. isronensis, B. jeotgali, B. kaustophilus, B. kobensis, B. kochii, B. kokeshiiformis, B. koreensis, B. korlensis, B. kribbensis, B. krulwichiae, B. laevolacticus, B. larvae, B. laterosporus, B. lautus, B. lehensis, B. lentimorbus, B. lentus, B. licheniformis, B. ligniniphilus, B. litoralis, B. locisalis, B. luciferensis, B. luteolus, B. luteus, B. macauensis, B. macerans, B. macquariensis, B. macyae, B. malacitensis, B. mannanilyticus, B. marisflavi, B. marismortui, B. marmarensis, B. massiliensis, B. megaterium, B. mesonae, B. methanolicus, B. methylotrophicus, B. migulanus, B. mojavensis, B. mucilaginosus, B. muralis, B. murimartini, B. mycoides, B. naganoensis, B. nanhaiensis, B. nanhaiisediminis, B. nealsonii, B. neidei, B. neizhouensis, B. niabensis, B. niacini, B. novalis, B. oceanisediminis, B. odysseyi, B. okhensis, B. okuhidensis, B. oleronius, B. oryzaecorticis, B. oshimensis, B. pabuli, B. pakistanensis, B. pallidus, B. pallidus, B. panacisoli, B. panaciterrae, B. pantothenticus, B. parabrevis, B. paraflexus, B. pasteurii, B. patagoniensis, B. peoriae, B. persepolensis, B. persicus, B. pervagus, B. plakortidis, B. pocheonensis, B. polygoni, B. polymyxa, B. popilliae, B. pseudalcalophilus, B. pseudofirmus, B. pseudomycoides, B. psychrodurans, B. psychrophilus, B. psychrosaccharolyticus, B. psychrotolerans, B. pulvifaciens, B. pumilus, B. purgationiresistens, B. pycnus, B. qingdaonensis, B. qingshengii, B. reuszeri, B. rhizosphaerae, B. rigui, B. ruris, B. safensis, B. salarius, B. salexigens, B. saliphilus, B. schlegelii, B. sediminis, B. selenatarsenatis, B. selenitireducens, B. seohaeanensis, B. shacheensis, B. shackletonii, B. siamensis, B. silvestris, B. simplex, B. siralis, B. smithii, B. soli, B. solimangrovi, B. solisalsi, B. songklensis, B. sonorensis, B. sphaericus, B. sporothermodurans, B. stearothermophilus, B. stratosphericus, B. subterraneus, B. subtilis, B. s. subsp. inaquosorum, B. s. subsp. spizizenii, B. s. subsp. subtilis, B. taeanensis, B. tequilensis, B. thermantarcticus, B. thermoaerophilus, B. thermoamylovorans, B. thermocatenulatus, B. thermocloacae, B. thermocopriae, B. thermodenitrificans, B. thermoglucosidasius, B. thermolactis, B. thermoleovorans, B. thermophilus, B. thermoruber, B. thermosphaericus, B. thiaminolyticus, B. thioparans, B. thuringiensis, B. tianshenii, B. trypoxylicola, B. tusciae, B. validus, B. vallismortis, B. vedderi, B. velezensis, B. vietnamensis, B. vireti, B. vulcani, B. wakoensis, B. weihenstephanensis, B. xiamenensis, B. xiaoxiensis, and B. zhanjiangensis.

6. The method of claim 1, comprising performing feed blending between 0.01 and 1 gram of microbes per kilogram of feed as a pre-mixed feed or coating.

7. The method of claim 1, comprising mixing between 1 and 5 grams of microbes per kilogram of feed.

8. The method of claim 1, comprising mixing between 1 and 5 grams of microbes per liter of water to form a drinking solution for animals.

9. The method of claim 1, comprising germinating in an upper digestive tract and act on predetermined sections of an intestine for nutrient absorption.

10. The method of claim 1, wherein the hull comprises corn or almond hull.

11. An apparatus, comprising:
a container for a carrier selected based on a predetermined animal:
for grazing animal, one of hull, wheat, and dendritic salt,
for poultry, dendritic salt or calcium carbonate,
for aquatic animal, dendritic salt;
for swine, dendritic salt or calcium carbonate; and
a microbial container housing a microbial solution with a plurality of strains of sporulated living microbes, wherein the microbial solution is applied to the carrier to form animal food; and
a source of liquid to activate the microbes after excretion.

12. The apparatus of claim 11, wherein the microbes comprise a member of Bacillus spp.

13. The apparatus of claim 11, comprising a carbon source growth medium container for the microbes.

14. The apparatus of claim 13, comprising a feed dispenser to feed animals with the infused hulls or shells to deliver micronutrients, microbial cultures and organic materials to a digestive tract, wherein microbes are germinated in the digestive tract and stimulate local intestinal immunity.

15. The apparatus of claim 11, comprising a centrifugal unit to concentrate fermented cell cultures, a dryer to perform lyophylisation, a quality control inspection unit.

16. The apparatus of claim 15, comprising a coater to coat a master seed culture.

17. The apparatus of claim 11, comprising a mixer to mix a master seed culture with a carrier.

18. The apparatus of claim 11, wherein the microbes comprise one or more of: Bacillus (B.) acidiceler, B. acidicola, B. acidiproducens, B. acidocaldarius, B. acidoterrestrisr, B. aeolius, B. aerius, B. aerophilus, B. agaradhaerens, B. agri, B. aidingensis, B. akibai, B. alcalophilus, B. algicola, B. alginolyticus, B. alkalidiazotrophicus, B. alkalinitrilicus, B. alkalisediminis, B. alkalitelluris, B. altitudinis, B. alveayuensis, B. alvei, B. amyloliquefaciens, B. a. subsp. amyloliquefaciens, B. a. subsp. plantarum, B. amylolyticus, B. andreesenii, B. aneurinilyticus, B. anthracia, B. aquimaris, B. arenosi, B. arseniciselenatis, B. arsenicus, B. aurantiacus, B. arvi, B. aryabhattai, B. asahii, B. atrophaeus, B. axarquiensis, B. azotofixans, B. azotoformans, B. badius, B. barbaricus, B. bataviensis, B. beijingensis, B. benzoevorans, B. beringensis, B. berkeleyi, B. beveridgei, B. bogoriensis, B. boroniphilus, B. borstelensis, B. brevis Migula, B. butanolivorans, B. canaveralius, B. carboniphilus, B. cecembensis, B. cellulosilyticus, B. centrosporus, B. cereus, B. chagannorensis, B. chitinolyticus, B. chondroitinus, B. choshinensis, B. chungangensis, B. cibi, B. circulans, B. clarkii, B. clausii, B. coagulans, B. coahuilensis, B. cohnii, B. composti, B. curdlanolyticus, B. cycloheptanicus, B. cytotoxicus, B. daliensis, B. decisifrondis, B. decolorationis, B. deserti, B. dipsosauri, B. drentensis, B. edaphicus, B. ehimensis, B. eiseniae, B. enclensis, B. endophyticus, B. endoradicis, B. farraginis, B. fastidiosus, B. fengqiuensis, B. firmus, B. flexus, B. foraminis, B. fordii, B. formosus, B. fortis, B. fumarioli, B. funiculus, B. fusiformis, B. galactophilus, B. galactosidilyticus, B. galliciensis, B. gelatini, B. gibsonii, B. ginsengi, B. ginsengihumi, B. ginsengisoli, B. globisporus, B. g. subsp. globisporus, B. g. subsp. marinus, B. glucanolyticus, B. gordonae, B. gottheilii, B. graminis, B. halmapalus, B. haloalkaliphilus, B. halochares, B. halodenitrificans, B. halodurans, B. halophilus, B. halosaccharovorans, B. hemicellulosilyticus, B. hemicentroti, B. herbersteinensis, B. horikoshii, B. horneckiae, B. horti, B. huizhouensis, B. humi, B. hwajinpoensis, B. idriensis, B. indicus, B. infantis, B. infernus, B. insolitus, B. invictae, B. iranensis, B. isabeliae, B. isronensis, B. jeotgali, B. kaustophilus, B. kobensis, B. kochii, B. kokeshiiformis, B. koreensis, B. korlensis, B. kribbensis, B. krulwichiae, B. laevolacticus, B. larvae, B. laterosporus, B. lautus, B. lehensis, B. lentimorbus, B. lentus, B. licheniformis, B. ligniniphilus, B. litoralis, B. locisalis, B. luciferensis, B. luteolus, B. luteus, B. macauensis, B. macerans, B. macquariensis, B. macyae, B. malacitensis, B. mannanilyticus, B. marisflavi, B. marismortui, B. marmarensis, B. massiliensis, B. megaterium, B. mesonae, B. methanolicus, B. methylotrophicus, B. migulanus, B. mojavensis, B. mucilaginosus, B. muralis, B. murimartini, B. mycoides, B. naganoensis, B. nanhaiensis, B. nanhaiisediminis, B. nealsonii, B. neidei, B. neizhouensis, B. niabensis, B. niacini, B. novalis, B. oceanisediminis, B. odysseyi, B. okhensis, B. okuhidensis, B. oleronius, B. oryzaecorticis, B. oshimensis, B. pabuli, B. pakistanensis, B. pallidus, B. pallidus, B. panacisoli, B. panaciterrae, B. pantothenticus, B. parabrevis, B. paraflexus, B. pasteurii, B. patagoniensis, B. peoriae, B. persepolensis, B. persicus, B. pervagus, B. plakortidis, B. pocheonensis, B. polygoni, B. polymyxa, B. popilliae, B. pseudalcalophilus, B. pseudofirmus, B. pseudomycoides, B. psychrodurans, B. psychrophilus, B. psychrosaccharolyticus, B. psychrotolerans, B. pulvifaciens, B. pumilus, B. purgationiresistens, B. pycnus, B. qingdaonensis, B. qingshengii, B. reuszeri, B. rhizosphaerae, B. rigui, B. ruris, B. safensis, B. salarius, B. salexigens, B. saliphilus, B. schlegelii, B. sediminis, B. selenatarsenatis, B. selenitireducens, B. seohaeanensis, B. shacheensis, B. shackletonii, B. siamensis, B. silvestris, B. simplex, B. siralis, B. smithii, B. soli, B. solimangrovi, B. solisalsi, B. songklensis, B. sonorensis, B. sphaericus, B. sporothermodurans, B. stearothermophilus, B. stratosphericus, B. subterraneus, B. subtilis, B. s. subsp. inaquosorum, B. s. subsp. spizizenii, B. s. subsp. subtilis, B. taeanensis, B. tequilensis, B. thermantarcticus, B. thermoaerophilus, B. thermoamylovorans, B. thermocatenulatus, B. thermocloacae, B. thermocopriae, B. thermodenitrificans, B. thermoglucosidasius, B. thermolactis, B. thermoleovorans, B. thermophilus, B. thermoruber, B. thermosphaericus, B. thiaminolyticus, B. thioparans, B. thuringiensis, B. tianshenii, B. trypoxylicola, B. tusciae, B. validus, B. vallismortis, B. vedderi, B. velezensis, B. vietnamensis, B. vireti, B. vulcani, B. wakoensis, B. weihenstephanensis, B. xiamenensis, B. xiaoxiensis, and B. zhanjiangensis.

19. The apparatus of claim 11, wherein the carrier comprises one of: almond hull, corn, wheat, amino acid, dendritic salt, calcium carbonate, and ground limestone.

20. The apparatus of claim 11, wherein the carrier for cattle comprises almond hull, wheat, and dendritic salt, wherein the carrier for poultry comprises dendritic salt or calcium carbonate, wherein the carrier for aquatic creature comprises dendritic salt, and wherein the carrier for swine comprises dendritic salt or calcium carbonate.
